(19) United States
(12) Patent Application Publication
(10) Pub. No.: US 2026/0194787 A1
(43) Pub. Date: Jul. 9, 2026

(54) EFFICIENT ATMOSPHERIC TRANSMISSION BROADBAND MULTISPECTRAL LASER SOURCE

(71) Applicant: The Government of the United States as represented by the Secretary of the Air Force, Wright-Patterson AFB, OH (US)

(72) Inventors: Christian Keyser, Milton, FL (US); Micah Raab, Crestview, FL (US); Trevor Courtney, Niceville, FL (US)

(21) Appl. No.: 19/081,222

(22) Filed: Mar. 17, 2025

Related U.S. Application Data
(60) Provisional application No. 63/742,413, filed on Jan. 6, 2025.

(51) Int. Cl. G02F 1/365; G01S 7/481

(52) U.S. Cl. CPC G02F 1/365; G01S 7/4814

(57) ABSTRACT

A broadband multispectral laser source has emission completely within, or substantially within, atmospheric transmission windows. This disclosed approach provides a path to more detailed control of the spectral distribution within one or more atmospheric transmission windows. For applications requiring transmission of a multispectral laser source through the atmosphere, such as LiDAR, it is desirable that the entire spectrum encounter low absorption such that the energy is used efficiently and longer operational ranges are achieved.

### CROSS-REFERENCE TO RELATED APPLICATIONS

Pursuant to 37 C.F.R. § 1.78(a)(4), this application claims the benefit of and priority to prior filed co-pending Provisional Application Ser. No. 63/742,413, filed Jan. 6, 2025, which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to broadband multispectral laser sources and, more particularly, to broadband multispectral laser sources with efficient atmospheric transmission.

### BACKGROUND OF THE INVENTION

Some types of electromagnetic radiation easily pass through the atmosphere, while other types do not. The ability of the atmosphere to allow radiation to pass through it is referred to as its transmissivity and varies with the wavelength/type of the radiation. The gases that comprise our atmosphere absorb radiation in certain wavelengths while allowing radiation with differing wavelengths to pass through. The areas of the electromagnetic spectrum that are absorbed by atmospheric gases such as water vapor, carbon dioxide, and ozone are known as absorption bands. Absorption bands represent a low transmission value that is associated with a specific range of wavelengths. In contrast to the absorption bands, there are areas of the electromagnetic spectrum where the atmosphere is transparent (little or no absorption of radiation) to specific wavelengths. These wavelength bands are known as atmospheric “windows” since they allow the radiation to easily pass through the atmosphere.

When broadband multispectral laser sources are transmitted through the atmosphere, it is desirable that the entire spectrum encounter low absorption such that the energy is used efficiently and longer operational ranges are achieved. However, the atmospheric absorption bands can cause inefficiency. FIG. 1 shows an exemplary MODTRAN simulated atmospheric transmission.

Systems requiring a broadband multispectral laser source typically employ a supercontinuum or continuum laser based on silica fiber. Although these laser sources are well characterized and are based on a common fiber material, silica, it is difficult to simultaneously scale the output power and engineer the spectrum. As shown in FIG. 2, high power continuum sources for Light Detection and Ranging (LiDAR) have been built around large mode area silica fibers but have the drawback of generating a significant part of their emission spectrum in the atmospheric absorption bands and/or outside of the detector sensitivity. This overlap of the spectrum and the atmospheric absorption bands causes these portions of the spectrum to be absorbed by the atmosphere. Thus, this poor overlap results in poor system efficiency as only a portion of the transmitted spectrum can be used by the system.

Accordingly, there is a need for a new laser source for LiDAR and other applications that is capable of simultaneously achieving high power and producing a spectrum confined, or near entirely confined, to the NIR-SWIR atmospheric transmission bands and InGaAs APD detector spectral responsivity bands or other desired detector spectral responsivity bands.

### SUMMARY OF THE INVENTION

The present invention overcomes the foregoing problems and other shortcomings, drawbacks, and challenges of providing broadband multispectral laser sources which permit simultaneous scaling of output power and engineering of the spectrum. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a nonlinear fiber-optic source for use with a pump laser to produce a broadband multispectral beam or beam pulses, the nonlinear fiber-optic source comprises one or more hollow-core fiber with each hollow core fiber having a hollow core, and configured to produce a transmission spectrum that transmits the pump laser and Raman generated spectrum, and one or more fluid filling the hollow core of the one or more hollow-core fiber. A wavelength of the pump laser and the one or more fluid are each chosen such that stimulated Raman scattering Stokes and anti-Stokes orders are substantially generated in one or more atmospheric transmission windows.

According to another embodiment of the present invention, a LiDAR system, comprises a laser for delivering broadband multispectral beam pulses that are directed toward and reflected off a target located within the atmosphere, and at least one detector receiving the beam pulses after the beam pulses are deflected off the target. The laser includes a pump laser and a nonlinear fiber-optic source. The nonlinear fiber-optic source includes one or more hollow-core fiber with each one or more hollow core fiber having a hollow core and configured to produce a transmission spectrum that efficiently transmits the pump laser and Raman generated spectrum, and one or more fluid filling the hollow core of the one or more hollow-core fiber. A wavelength of the pump laser and the one or more fluid are each chosen such that stimulated Raman scattering Stokes and anti-Stokes orders are substantially generated in one or more atmospheric transmission windows and at least one response window of the at least one detector.

According to yet another embodiment of the invention, a method of producing an efficient atmospheric transmission from broadband multispectral laser, comprising the steps of selecting one or more spectral ranges within which emission will be generated, obtaining a pump laser that produces a wavelength on a short wavelength side of the selected one or more spectral ranges, determining which Raman shifts are necessary to go from the pump laser wavelength to one or more selected spectral ranges, obtaining a nonlinear fiber-optic source for use with the pump laser to produce broadband multispectral beam pulses. The nonlinear fiber-optic source comprises one or more hollow-core fiber. An additional step is selecting at least one liquid or at least one gas for filling the one or more hollow-core fiber to provide the determined Raman shifts and having sufficient optical transmission and nonlinear gain to support efficient Raman generation.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a graph showing MODTRAN simulated atmospheric transmission.

FIG. 2 is a graph showing a near infrared (IR) to short-wave IR silica fiber supercontinuum (SC) spectrum (where shaded bands indicate absorption bands).

FIG. 3 is a schematic view of a high-power pump laser shined into a gas (or liquid) filled fiber with Ramon generator.

FIG. 4 shows a common 1.06 um laser (E=9434 cm⁻¹) shown as an arrow on an atmospheric T plot.

FIG. 5 also shows a common 1.06 um laser (E=9434 cm⁻¹) shown as an arrow on an atmospheric T plot.

FIG. 6 is a graph showing a spectrum generated by an O₂ filled hollow core fiber pumped by a ~1.06 um laser to generate a vibrational line in each atm transmission window.

FIG. 7 is another graph showing the spectrum generated by an O₂ filled hollow-core fiber pumped by a ~1.06 um laser to generate a vibrational line in each atmospheric transmission window of FIG. 6.

FIG. 8 is a schematic view of a high-power pump laser shined into multiple gas filled hollow-core fiber with serial Raman generators.

FIG. 9 is a flow-chart showing an exemplary method of making a broadband multispectral laser source according to the present invention.

FIG. 10 is a block diagram for a LiDAR system including a laser source according to the present invention.

FIG. 11A is a molecular diagram of oxygen molecules converting pump photons to rotational Raman Stokes and anti-Stokes photons as well as pure vibrational Raman Stokes photons.

FIG. 11B is an energy level diagram of pure vibrational and rotational Raman transitions.

FIG. 11C shows spectra of the rotational Raman lines (produced by a 20-kW pump laser) associated with P, S1, and S2

FIG. 12 illustrates spectra of fiber Raman output at various pump peak powers. The incident pump peak powers are given in the corresponding spectra. Lines are superimposed on P, S1, and S2 respectively. Brackets on top of the spectra indicate the branches associated with P, S1, and S2. In order to estimate the absolute power for each wavelength, the spectra were scaled by the following factor: measured power over 1175-1550 nm/area under the spectrum between 1175-1550 nm. Superimposed on the top panel is the atmospheric transmission spectrum.

FIG. 13 is a plot of power from P, S1 and S2 (and associated branches) as a function of input pump peak power.

FIG. 14 illustrates spectra of fiber Raman output pumped by 80 kW peak power of a linearly and a circularly polarized pump.

FIG. 15 shows wavelength versus temporal delay based on the dispersion of the DCF4 (top panel). Temporal profile of fiber Raman output (produced by 40 kW pump power) after being temporally separated in a 3 km DCF4 fiber (bottom panel).

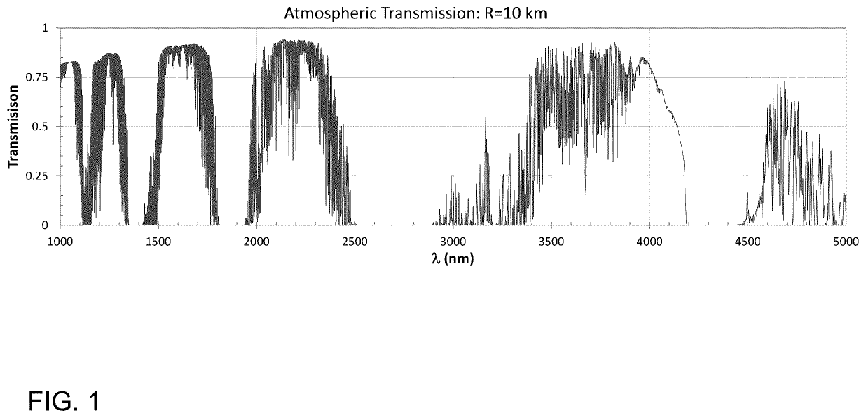

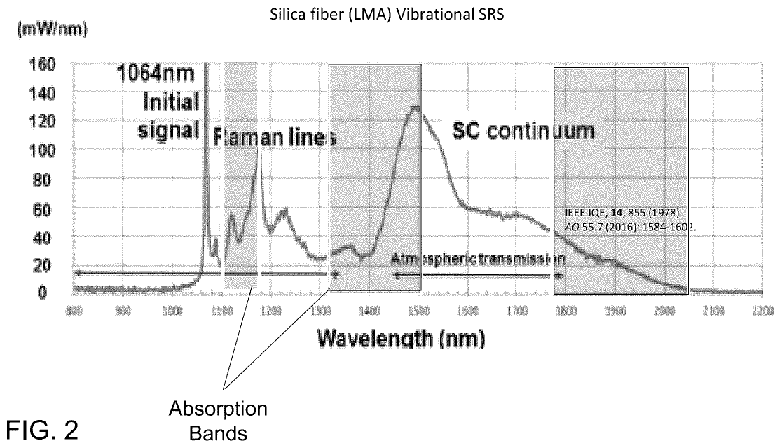

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

The purpose of the present invention is to provide multispectral laser sources having emission completely within, or mostly within, the atmospheric transmission windows. Additionally, the approach provides a path to more detailed controlled of the spectral distribution within an atmospheric transmission window. For applications requiring transmission of a multispectral laser source through the atmosphere, it is desirable that the entire spectrum encounter low absorption such that the energy is used efficiency and longer operational ranges are achieved.

The broadband multispectral source, according to the present invention has two core elements: 1. a hollow-core fiber designed to have a transmission spectrum that efficiently transmits the pump laser and Raman generated spectrum; and 2. a liquid(s) or a gas(es) filling the hollow-core fiber to produce vibrational and rotational Raman shifts consistent with converting the pump laser wavelength to wavelengths within the atmospheric transmission bands and the detector response band. Current technology dictates that the hollow-core fiber is based on some variation of an anti-resonant hollow-core photonic-crystal fiber for a gas fill or low index liquid, and a photonic-crystal fiber or hollow capillary for high index liquids. One particular embodiment includes an O2 filled anti-resonant hollow-core fiber pumped by a ~1.01-1.08 um laser. This embodiment produces three (or more) broad bands of rotational-vibrational emission with each band coincident with the atmospheric transmission windows and within the spectral response of an InGaAs APD detector. O₂ in particular has attractive Raman shifts using a ~1.06 um pump, the O₂ vibrational shift of 1550 cm−1 creates the first vibrational Raman order at 1275 nm and a 2nd vibrational order at 1590 nm (each order is in a different atmospheric transmission band). The ~8 cm−1 rotational shift then creates a broad spectrum of rotational shifts around the pump, 1st, and 2nd order vibrational lines providing the potential to fill each atmospheric band. The large core of the hollow-core fiber allows for generation of high peak power output. Designs to support broad spectral emission in different wavelength regions or using a different pump laser would likely require a different Raman medium.

It is noted that more than three broad bands of rotational-vibrational emission can be produced with each band coincident with the atmospheric transmission windows. For example, but not limited to, emission in a 4^{th} atmospheric transmission window around 2.1 um. Although this 4^{th} emission band isn't detectable by an InGaAs APD it is detectable by other materials such as, for example but not limited to, HgCaTe.

Thus, this new multispectral laser source is capable of simultaneously achieving high power and producing a spectrum confined, or almost entirely confined, to the NIR-SWIR atmospheric transmission bands and the InGaAs APD detector spectral responsivity bands (~1.0-1.7 um). The new source is based on stimulated rotational-vibrational Raman scattering in a O₂ filled anti-resonant hollow-core photonic crystal fiber.

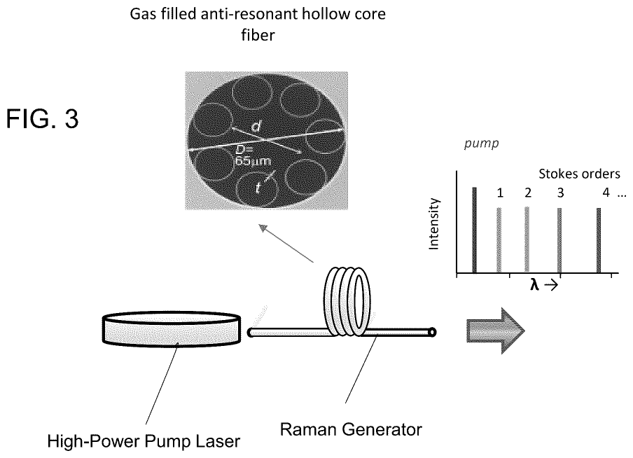

As best shown in FIG. 3, a high-power pump laser is shined into a gas (or liquid) filled fiber. The pump laser wavelength and gas (or liquid) is chosen such that the stimulated Raman scattering Stokes and anti-Stokes orders are generated in the atmospheric transmission windows. The Stokes/anti-Stokes orders are generated at ω_{AS,S}=ω_{L}±Nδ where ω_{AS,S} is the anti-Stokes, Stokes frequency, ω_{L} is the laser frequency, δ is the Raman shift, and N is the number of orders generated. As orders are at higher frequency (+) whereas Stokes orders are at lower frequency (−); Stokes orders tend to be generated at much power than AS orders. The greater the N, the greater the pump power required.

The Raman medium is chosen such that ω_{AS,S}=ω_{L}+Nδ is within the atmospheric transmission window. Consider the 1.0-1.7 um atmospheric transmission spectrum in wavenumbers. This is a useful spectral region due to the fact that InGaAs APD detectors operate over this range.

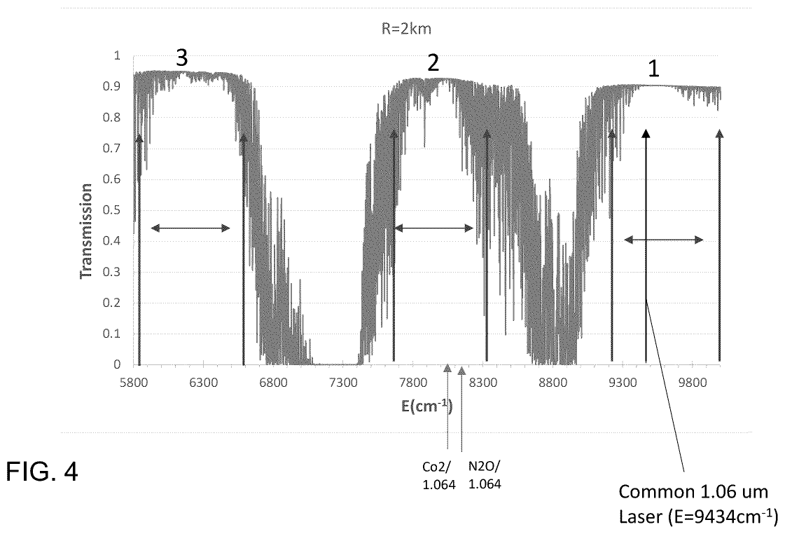

For example, consider the common 1.06 um laser (E=9434cm⁻¹) shown as the red arrow on an atmospheric T plot of FIG. 4. The desired Raman orders fall within the blue arrows that indicate the limits of each of the atmospheric transmission windows in this example. To shift from the 1.06 um pump to window 2 would require a shift of δ~1000-1700 cm⁻¹ and to shift to window 3 would require δ~2800-3600 cm⁻¹.

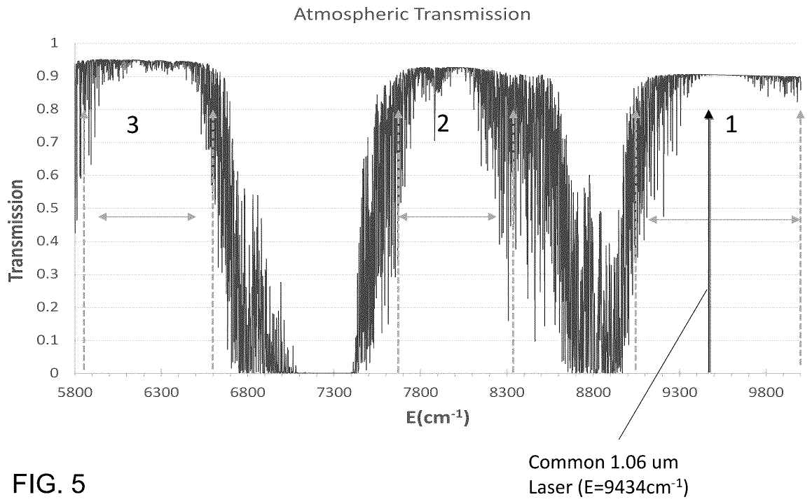

Also, for example, consider the same pump laser but with the goal of filing the spectral region around the pump in window 1 with Raman lines. Shifts of δ~≤−200 to +600 cm⁻¹ would generate 1 or more Raman lines within window 1 (see FIG. 5).

### Single Gas Species

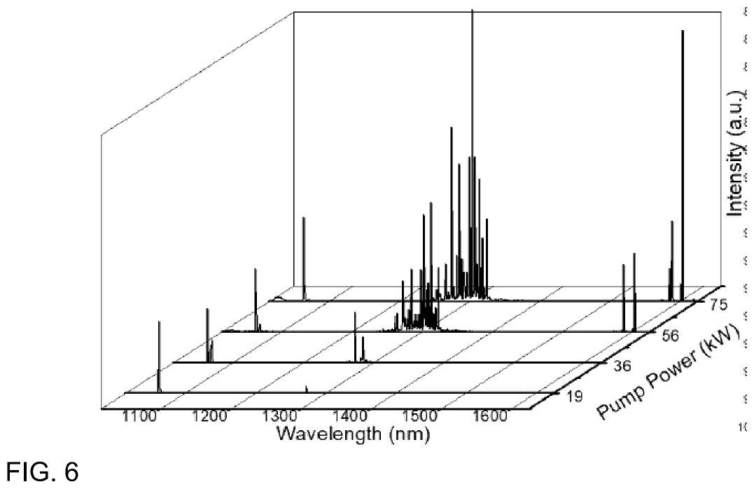

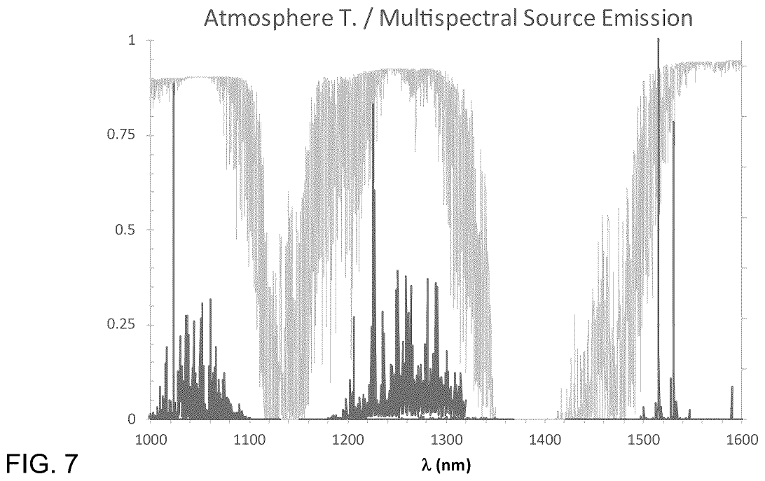

Unfortunately, there are few media with the desired Raman shifts that are also transmissive and safe. Molecular oxygen, O₂ is one of the few good candidates for the present invention. O₂ has a vibrational shift of 1550 cm−1 and a rotational shift of 12 cm−1 which enables an O₂ filled hollow core fiber pumped by a ~1.06 um laser to generate a vibrational line in each atmospheric transmission window and then for rotational lines to be generated around each pump and vibrational line. A spectrum collected in our lab is shown in FIGS. 6 and 7. It is noted that any other suitable gas can be utilized.

### Liquid

Liquid filled fiber requires an anti-resonant HCF for liquid with n_{liquid}<n fiber and a hollow capillary fiber or photonic crystal fiber for n_{liquid}≥n fiber where n is the index of refraction. We have not identified promising candidate liquids. It is noted that any other suitable liquid can be utilized.

### Gas Mixtures

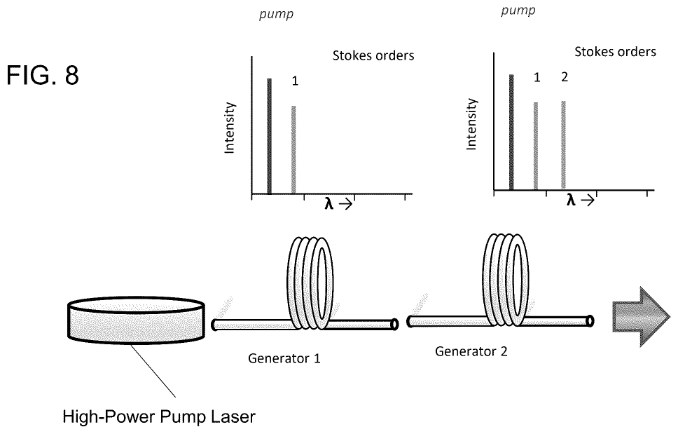

Another method is to use multiple gas species. One or multiple gases may be used in a single hollow-core fiber. As best shown in FIG. 8, for serial Raman generators, a first hollow-core fiber is filled with gas 1 to generate Raman in atmospheric window 2. The pump and a first Raman order (in window 2) are coupled into a second hollow core fiber filled with gas 2 which generates Raman in window 3. The second hollow core fiber emits the pump and two Raman orders, one in windows 2 and 3. The Raman emission from the second hollow-core fiber can occur from a Raman shift from the pump or the Raman order generated in the first hollow-core fiber dependent on the gas selection.

For example, but not limited to, window 2 single vibrational shift candidates (requires ~1000-1700 cm−1 shift using a 1.06 um pump are): 1. CO₂ (1388 cm−1, 1286 cm−1); 2. N²O (1285 cm−1); and 3. SO₂ (1151 cm−1). Also, for example but not limited to, window 3 single vibrational shift candidates (requires 2800-3600 cm−1) are: 1. NH₃ (3334 cm−1); 2. CH₄ (2914 cm−1); 3. C₂H₄ (3020 cm−1); and 4. D₂ (2990 cm−1). It is noted that any other suitable gas combination can be utilized.

In a second approach, a first gas species provides multiple shifts into window 1 while a second gas species shifts the first gas species Raman emission into window 2. _{Window} 1 cascade of shifts candidates (requires sum of shifts to=~1000-1700 cm−1 shift using a 1.06 um pump) are: 1. H₂ rotational (587 cm−1): 2-3 shifts can generate 1-2 lines in window 1; and 2. Silica vibrational (493 cm−1): ~2-3 shifts can generate 1-2 lines in window 1. Note that Silica shifts would be used in solid core fiber. Window 2 single shift candidates (requires 2800-3600 cm−1) are: 1. NH₃ (3334 cm−1); 2. CH₄ (2914 cm−1); 3. C₂H₄ (3020 cm−1); and 4. D₂ (2990 cm−1). It is noted that any other suitable gas combination. can be utilized.

In a third approach, gas combinations are used to generate multiple lines in each window. Window 1 candidates (requires sum of shifts to=~1000-1700cm−1 shift using a 1.06 um pump) and candidates are CO₂ (1388 cm−1, 1286 cm−1)+N₂O (1285 cm−1)+SO₂ (1151 cm−1). Window 2 Single Shift candidates (requires 2800-3600 cm−1) are NH₃ (3334 cm−1)+CH₄ (2914 cm−1) [or D₂]+C₂H₄ (3020 cm−1). It is noted that any other suitable gas combi nation can be utilized.

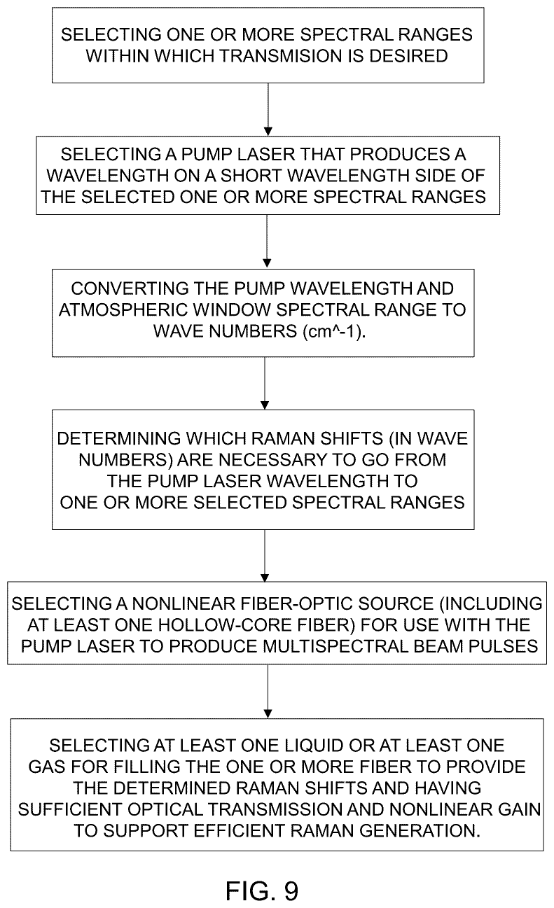

As best shown in FIG. 9, a method of making an efficient atmospheric transmission broadband multispectral laser source according to the present invention includes the step of selecting spectral ranges or windows (high atmospheric transmission windows) to generate emission in. The next step is selecting or developing a laser on a short wavelength side of the spectral range you want to operate in (this can be challenging as there are a few common high power pump laser wavelengths and if you deviate from those you are forced to either develop a new laser or use a nonlinear optical method to generate the necessary wavelength). The short wavelength side is chosen for the pump laser as Raman generation tends to occur at wavelengths longer than the pump wavelength. With the pump laser wavelength on the short side of the spectral bands of interest, the next step is converting the pump wavelength and atmospheric window spectral range to wavenumbers (cm^−1). Note that Raman shifts are most easily understood in terms of wavenumbers. The next step is determining which Raman shifts (in wavenumbers) are necessary to go from the pump laser wavelength to the desired atmospheric transmission windows.

After the required Raman shifts are known, the next step is selecting at least one liquid or at least one gas that provides the required Raman shift and sufficient optical transmission and nonlinear gain to support efficient generation. The liquid or gas can be selected by search molecular databases. This also requires having some knowledge of fiber optics so you can design a fiber to work with the liquid or gas as dictated by its index of refraction. Depending on the type of pump laser, the pump laser wavelength can have a little bit of tunability to walk the Raman emission into the atmospheric transmission bands. For example, fiber lasers use a glass medium which broadens the emission gain and allows some tunability. Lasers based on crystals often do not have this flexibility. The inventors looked at the ~1 um to ~2.2 um band. Here the inventors found that there are only a few single molecular species capable of generating Raman emission largely confined to the atmospheric transmission window. O₂ appears to be the best. CO₂ may work. Another option is selecting a gas combination to accomplish the goal. Here one may mix the gases in a single fiber or uses serial fibers each having a different gas. It is noted that the disclosed method can include additional steps and/or the steps can be performed in any other suitable order.

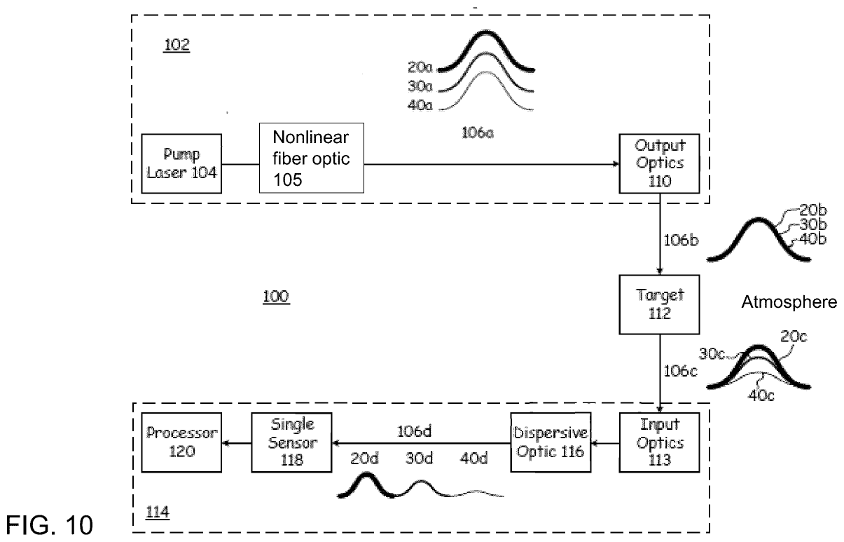

FIG. 10 illustrates a spectral LiDAR system 100 including an efficient atmospheric transmission broadband multispectral laser source according to the present invention. The LiDAR system 110 includes a transmitter 102 with a pump laser 104. The pump laser 104 pumps the above-described nonlinear fiber optic 105 including a hollow-core fiber designed to have a transmission spectrum that efficiently transmits the pump laser and Raman generated spectrum; and liquid(s) or gas(es) filling the hollow-core fiber having vibrational and rotational Raman shifts consistent with converting the pump laser wavelength into wavelengths within the atmospheric transmission bands and the detector response band to produce an efficient atmospheric multispectral laser. The multispectral laser creates an original beam pulse 106a.

Output optics 110 receive the original beam pulse 106a and directs an incident beam pulse 106b toward a target 112 located within the atmosphere, which scatters the incident beam pulse 106b into a reflected beam pulse 106c. A receiver 114 captures portions of the reflected beam pulse 106c with input optics 113 that pass the reflected beam pulse 106c along to that pass the reflected beam pulse 106c along to a dispersive optic 116.

The dispersive optic 116 temporally disperses the wavelengths of the reflected beam pulse 106c (spreads different wavelengths out over time), and thereby produces a temporally dispersed beam pulse 106d, which is directed to just one single-pixel sensor or detector 118. The single-pixel sensor 118 measures the intensity of the dispersed beam pulse 106d versus time, which yields reflectivity information in regard to the reflectivity of the target 110 at each of the wavelengths in the reflected beam pulse 106c.

The detector 118 can be, for example but not limited to, an InGaAs APD detector or the like. The detector 118 can be operably connected to a controller 120 if desired to process the beam pulse 105c received by the detector 118. As a result, the LiDAR system 100 simultaneously achieves both high power and producing a spectrum confined, or near entirely confined, to the NIR-SWIR atmospheric transmission bands and InGaAs APD detector spectral responsivity bands or other desired detector spectral responsivity bands. See U.S. Pat. No. 10,871,554 issued to Keyser et a. on Dec. 22, 2020, which is incorporated herein in its entirety by reference, for more information regarding temporally-dispersed LiDAR.

For spectral LiDAR there needs to be some way to differentiate signal at each wavelength. The above=described LiDAR temporally disperses the wavelengths−spread them out in time−and uses a single pixel detector to measure all spectral content. Conventional spectral lidar uses a grating to separate wavelengths out in space and an array of detectors—1 pixel/wavelength per detector—records the signal at each wavelength. It is noted that any other suitable method for differentiating the signal at each wavelength can alternatively be utilized.

From the above description, it should be apparent that potential commercial uses of the present invention include, but are not limited to, spectral LiDAR for defense, metrology, chemical/biological sensing, vegetation/mineral LiDAR mapping, target illumination, and as a target dazzler.

Nonlinear optical processes such as second harmonic generation, four wave mixing and stimulated Raman scattering (SRS) have long been used for wavelength conversion. Inefficiency of nonlinear optical processes sometimes necessitates longer interactions lengths; one interesting solution for SRS is the use of hollow core fibers filled with a desired material. Photonic crystal fiber (PCF) filled with hydrogen gas has been used to convert 1064 nm pump radiation to 1135 nm with 92 percent quantum conversion efficiency through SRS. Such high conversion efficiencies enable produced vibrational or rotational SRS lines to pump higher SRS orders resulting in multiple, evenly spaced spectral lines. For example, first and second vibrational orders have been produced from SF₆ and CH₄ filled PCF fibers.

Hydrogen filled optical fiber has been used to produce 6 orders of stimulated rotational Raman lines. When pumped by 1064 nm, these lines exist in the short wavelength IR (SWIR) band (900-1700 nm) and can be used for multi-spectral light detection and ranging (LiDAR). Since the wavelength-dependent reflectivity varies from one material to another, the use of multiple wavelengths would in principle allow one to identify the materials of a scene regardless of the object shape. Use of multiple wavelengths is superior to a single wavelength in identifying objects and this advantage has been used in multiband and hyperspectral LiDAR. This motivates use of many wavelengths within the atmospheric transmission windows. Previously, the Raman orders were temporally separated using the chromatic dispersion of an optical fiber (without use of a grating) to demonstrate temporally dispersed LiDAR. However, in this demonstration only some of the Raman orders of hydrogen overlap with the atmospheric transmission windows. The 1550 cm−1 vibrational Raman shift of molecular oxygen gas is ideal for atmospheric transmission as it could convert 1030-1070 nm pump radiation into three SRS orders that all lie in atmospheric transmission windows centered at approximately 1.05, 1.27, and 1.6 μm. Additionally, the closely spaced rotational lines of oxygen could enable broad coverage of the spectral space within an atmospheric window for hyperspectral or multiband LiDAR. While others have reported spontaneous Raman produced from oxygen filled fiber, to the best of our knowledge, measurement of SRS from an oxygen filled fiber has not been reported to date.

The much larger core diameter (compared to a PCF) of an antiresonant fiber (ARF) allows for power scaling which is an important metric for LiDAR applications. It is thus well suited to producing strong higher SRS orders in a low Raman gain medium such as molecular oxygen. The guidance mechanism of an ARF is based on anti-resonance of the strut thickness with the supported light wavelengths. The wavelengths that are not supported by an ARF (λm) are approximated by the ARROW model.

We have demonstrated a transmitted 1064 nm pump as well as the first and second vibrational Stokes SRS orders produced from an oxygen filled ARF. To the best of our knowledge, this is the first report of SRS generated in an oxygen filled fiber. All three of these lines exist near the center of three SWIR atmospheric transmission windows and are accompanied by a host of closely spaced rotational SRS lines. At higher pump powers, these lines broadened to form continuum bands which enable broad spectral coverage in a potential multi-band LiDAR application. To demonstrate applicability to temporally dispersed LiDAR, we temporally separate the orders using the chromatic dispersion of a non-zero dispersion shifted silica fiber and measure the spectrum in the time domain.

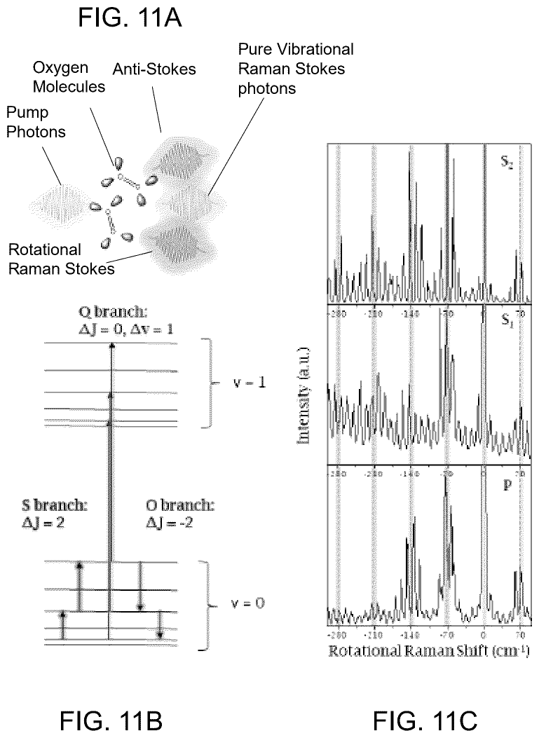

The molecular diagram of FIG. 11A depicts the conversion of pump photons into rotational Raman Stokes and anti-Stokes photons as well as pure vibrational Raman Stokes photons by molecular oxygen. The energy level diagram in FIG. 11B depicts the pure rotational and vibrational Raman transitions in molecular oxygen. It is well known that the vibrational quantum number (v) changes by 1 during a transition: Δv=+/−1. There is insufficient thermal energy at 20° C. to significantly populate the vibrational excited state so only the vibrational Stokes transition contributes significantly. This is why the only vibrational transition in the figure is the v0→v1 transition. The set of Raman lines for which only Δv is nonzero is called the Q branch and is indicated as grey lines in the center of the energy level diagram. The selection rule for rotational transitions is as follows: ΔJ=+/−2. Here, J is the rotational quantum number which defines the rotational levels. The spacing between the rotational levels is 6 cm−1, but every other rotational level is not populated due to wavefunction symmetry considerations so the spacing between Raman rotational lines is approximately 12 cm−1. As a result of this small spacing, there is significant thermal population of the rotational excited states and there are many possible ΔJ=2 (Stokes) and ΔJ=−2 (anti-Stokes) rotational Raman transitions. These constraints upon the rotational transitions are represented in FIGS. 11A-C. The groups of rotational lines which are rotational Stokes or anti-Stokes are called the S or O branches respectively which are indicated by the red and blue arrows in FIG. 11B.

Twenty meters of antiresonant fiber was obtained from Rodrigo Amezcua Correa at the University of Central Florida. The core diameter and strut thickness are 31.7 μm and 330 nm, respectively. The fiber was pumped by a 0.5 ns 1064 nm laser purchased from Photonics Industries (M2<1.2) at a repetition rate of 20 kHz. The fiber input and output ends were housed within gas cells which were pressurized with 20.0-20.2 bar of industrial grade oxygen gas; within the gas cells the optical fiber ends were clamped with a customized fiber fixture in order to mechanical perturbations during optical pumping. Because the SRS gain of oxygen gas is significantly lower than that of hydrogen or methane, for example, we used a relatively high pressure to increase the number density within the fiber. The pump laser was focused to a spot size of 27 μm in order to couple into the fiber. When the fiber and cells were un-pressurized, the optical throughput of the fiber was 67 percent; however, the throughput would reproducibly fall to 30-40 percent after pressuring and allowing for equilibration. We believe this low throughput is caused by optical absorption and scattering brought about by impurities of the industrial grade oxygen gas. Another possibility is that oxygen is reacting with impurities to create particulates on the fiber facet, causing further scattering. The ARF loss at 1064, 1276, and 1592 nm is approximately 60, 50, and 110 dB/km, respectively. Unless explicitly stated in the following text, the polarization of the pump laser was linear. Spectra were acquired by coupling the ARF optical output to an optical spectrum analyzer (OSA).

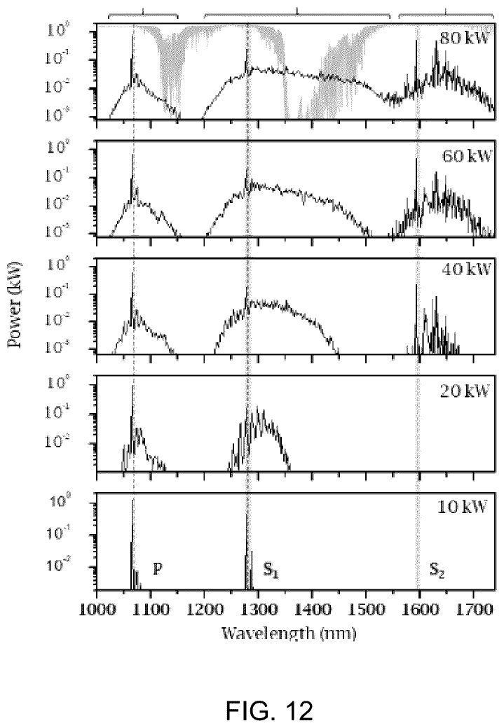

FIG. 11C shows spectra of the rotational SRS lines associated with the pump laser (P) at 1064 nm, the first Stokes Q branch order (S1) at 1276 nm, and the second Q branch Stokes order (S2) at 1592 nm. The S indicates a vibrational Stokes shift and not to be confused with the S branch. The measured vibrational and rotational Raman shifts match the literature values at approximately 1550 and 12 cm−1 respectively. It is clear that the Stokes lines are much stronger than the anti-Stokes lines. Thermal population differences in the rotational levels cause the rotational Stokes lines to have higher intensities than those of the corresponding anti-Stokes lines in spontaneous Raman spectra. The difference of intensities between the Stokes and anti-Stokes lines becomes larger than that of spontaneous Raman spectra because the nonlinear optical SRS process scales exponentially with the Raman gain coefficient which is directly related to the number density of the medium. Thus, this difference is even more pronounced is SRS spectra. There are groups of Raman Stokes and anti-Stokes lines that have significantly higher intensity than others. The coherent anti-Stokes Raman scattering (CARS) lines of highest intensities (due to the thermal population distribution) in the S and O branches are approximately +/−72 cm−1 shifted from the Q branch. Thus, the two groups of lines shifted approximately +/−70 cm−1 are most likely the lines of highest intensity of the S and O branch respectively. The second group of lines shifted by −140 cm−1 result from the most intense lines of the S branch pumping a second branch. The set of lines shifted by −210 cm−1 and −280 cm−1 indicates this process repeats. Clearly, Raman intensity extends well beyond 280 cm−1 as a result of this cascade process. The effect becomes more pronounced at higher pump powers as will be shown. The measured fiber output produced by various pump powers is shown in FIG. 12. The atmospheric transmission spectrum (ranging from 20-100 percent) is superimposed on the top panel. As the input pump power was increased, the intensity of the vibrational orders and rotational lines increased. The lines then formed continuum bands around P, S1, and S2 upon increase of incident pump power beyond 10 kW. It is known that combinations of SRS, self-phase modulation, and four wave mixing can contribute to continuum formation in optical fiber. Four wave mixing likely has little to no contribution in our case because of phase matching requirements. We believe all peaks of the spectra are due to SRS and are at least the major contribution to the continua. It is possible that self-phase modulation plays some role in spectral broadening. Additionally, the Q, S, and O Raman branches are known to broaden with increased pressure. According to Gordon, collisions can introduce rotational phase shifts, reorientation, and rotational energy transfer which all contribute to broadening of rotational Raman spectra in gases. This broadening effect has been observed in spontaneous and stimulated Raman spectra. In case at 20 bar, the full width at half max of the J=11 level of the S branch was approximately 0.6 cm−1 which is near the predicted value based on the broadening coefficient of oxygen (0.036 cm−1/atm). Researchers have shown that spontaneous Raman show rotational lines do not extend beyond 300 cm−1 due to thermal populations of rotational levels. For example, the S branch corresponding to S1 would terminate at approximately 1325 nm. In our work, especially for high pump powers, the SRS intensity in FIG. 12 extends much further than 300 cm−1. In fact, at 80 kW of pump power, the S branches associated with S1 overlaps the O branch corresponding to S2, a shift larger than 1100cm−1. The reason for this dramatic extension is that the S and O rotational branches can pump other branches (at high pump powers) as previously indicated. We did not observe the S3 order, presumably due to high fiber loss at 2.1 μm. The top panel shows that much of the Raman output overlaps with the atmospheric transmission windows. As pointed out previously, SRS Stokes intensities are significantly greater than those of the SRS anti-Stokes. So, while much intensity is within the atmospheric transmission windows, a significant amount of intensity from the S branches exist outside the atmospheric transmission windows for higher pump powers. In order to make more use of the rotational lines for hyperspectral LiDAR, the lines must be centered in the atmospheric transmission windows. This can be achieved by pumping with a higher energy wavelength such as 1040 nm.

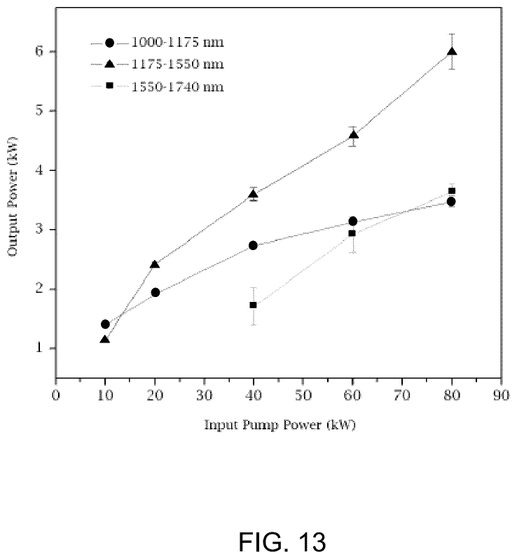

In addition to laser beam quality and laser stability, the absolute power of the P and SRS lines is an important factor for LiDAR. The powers of P, S1, and S2 and the associated S and O branches were determined by spectrally separating the collimated ARF output with a grating (Thorlabs part number GR25-0610), then measuring the powers with a thermopile power meter (Thorlabs item number S401C). The diffraction efficiency of the grating was accounted in the reported powers. The output pulse power of P, S1, and S2 and associated S and O branches (1000-1175, 1175-1550, and 1550-1740 nm) as a function of pump input power is given in FIG. 13.

For pump input powers greater than 70 kW, the power of S2 exceeds that of P, near 4 kW.

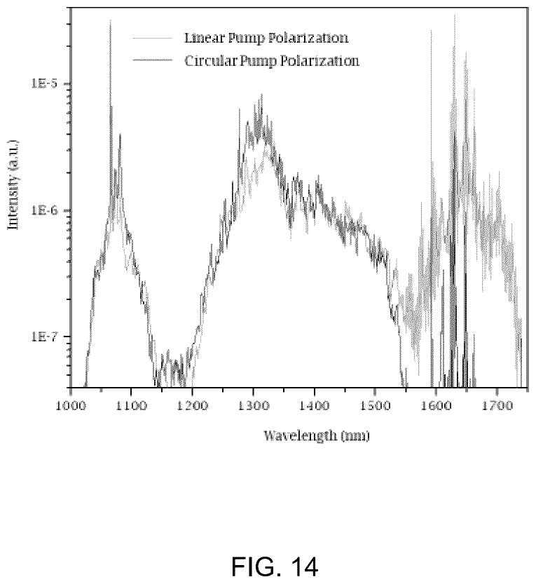

The Raman fiber output was significantly dependent on the pump polarization. FIG. 14 shows the fiber output produced by circularly polarized pump light and linearly polarized light. Linear polarization favors S2, while a circularly polarized pump light results is higher intensity at P and S1. The reason for this effect is that circular or linearly polarized pump light favors pure rotational or pure vibrational SRS respectively. This dependence allows for control over the output spectral distribution. For example, use of circularly polarized pump would maximize power at P and S1 for LiDAR applications.

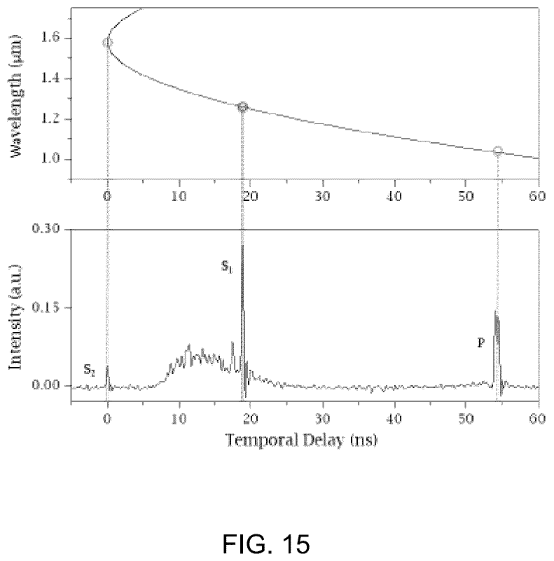

In order to demonstrate that one can temporally separate the Raman lines, the optical output of the ARF was attenuated and launched into a 3 km non-zero dispersion-shifted solid core silica fiber purchased from Thorlabs (part number: DCF4). We selected this dispersion shifted fiber so that the orders exiting the fiber would be temporally separated. For a standard telecom fiber, the presence of the zero dispersion-shifted wavelength (ZDW), near 1.3 μm, in the center of the SRS spectrum would cause the section of SRS spectrum with wavelengths longer than the ZDW to temporally fold over on section of the SRS spectrum with wavelengths shorter than the ZDW. The output signal was then measured in the time domain using a fast photodiode (5 GHz bandwidth) and oscilloscope. The top panel of FIG. 15 shows wavelength versus temporal delay calculated from the dispersion of the 3 km DCF4. The bottom panel shows the temporally dispersed SRS spectrum (produced by 20 kW of pump power) using the 3 km of DF4. P, S1, and S2 centered at approximately 54, 18, and 0 ns, respectively are color coded green, purple and orange, respectively. These relative temporal delay agree with the dispersion of the DCF4 fiber. The narrow temporal profile of S2 and the small temporal separation between S1 and S2 (compared to P and S1 spacing) occur because the S2 wavelength is very close to the zero-dispersion wavelength of the DCF4. We, for the first time, used an oxygen filled fiber to produce the first and second vibrational SRS orders (along with the transmitted pump), all centered within three atmospheric transmission windows. At higher pump powers, the closely spaced rotational lines produce continuum bands. Since the Stokes rotational SRS lines are much favored, the continua become decentered within the atmospheric transmission windows. The spectral overlap of the continuum bands with the atmospheric transmission windows can be maximized by optimizing pump wavelength and fiber transmission spectrum. We have temporally separated these lines using a dispersive fiber intended for use in multi-band LiDAR at three atmospheric transmission windows.

From the above, it is clear that wavelength conversion afforded by stimulated Raman scattering within hollow core fiber is potentially useful for multispectral LiDAR. Herein, we make use of the ideal 1550 cm−1 vibrational Raman shift of an antiresonant fiber filled with gaseous oxygen so that the first and second Raman orders as well as the transmitted pump are all located in separate atmospheric transmission windows. To the best of our knowledge, this is the first report of stimulated Raman scattering in an oxygen filled fiber. The host of closely spaced rotational SRS lines (12 cm−1) accompanying the transmitted pump and vibrational Raman orders form continuum bands allowing for much greater spectral coverage of the atmospheric transmission windows. The temporal profiles of the Raman orders can be separated without the use of a grating to potentially achieve multi-band LiDAR.

The phrase “and/or” as used in this specification should be understood to mean “either or both” of the elements being referred to, i.e., elements that are conjunctively present in some instances and disjunctively present in other instances. Other elements may optionally be present other than the elements specifically identified by the “and/or” clause, whether related or unrelated to those elements specifically identified unless clearly indicated to the contrary.

As used in this specification, the term “preferably” refers to one or more exemplary embodiments of the invention and therefore is not to be interpreted in any limiting sense.

The terms “comprises,” “comprising,” “includes,” “including,” “has,” “having,” or any other variations thereof used herein, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a” does not, without more constraints, preclude the existence of additional identical elements in the process, method, article, or apparatus that comprises the element.

Reference to “one embodiment,” “certain embodiments,” “an embodiment,” “implementation(s),” “aspect(s),” or similar terms used herein means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

It will be understood that terms of orientation and/or position as may be used throughout the specification and claims, such as upper, lower, rear, side, forward, downward, upward, inner, and so on, as well as their derivatives and equivalent terms, relate to relative rather than absolute orientations and/or positions.

All patents, patent applications (and any patents which issue thereon, as well as any corresponding published foreign patent applications), publications, and other documents mentioned throughout this description are hereby incorporated by reference herein. It is expressly not admitted, however, that any of the documents incorporated by reference herein teach or disclose the present invention.

The words “about,” “approximately,” or the like, when accompanying a numerical value, are to be construed as indicating a deviation as would be appreciated by one of ordinary skill in the art to operate satisfactorily for an intended purpose.

It should be understood that every maximum numerical limitation used herein includes every lower numerical limitation, as if such lower numerical limitations were expressly written herein. Every minimum numerical limitation used herein includes every higher numerical limitation, as if such higher numerical limitations were expressly written herein. Every numerical range herein includes every narrower numerical range that falls within such broader numerical range, as if such narrower numerical ranges were all expressly written herein.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

References herein to items in the singular should be understood to include items in the plural, and vice versa, unless explicitly stated otherwise or clear from the text.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described.

Accordingly, departures may be made from such details without departing from the scope of the general inventive concept.

What is claimed is:

1. A nonlinear fiber-optic source for use with a pump laser to produce a broadband multispectral beam or beam pulses, the nonlinear fiber-optic source comprising:
one or more hollow-core fiber with each hollow core fiber having a hollow core and configured to produce a transmission spectrum that transmits the pump laser and Raman generated spectrum; and
one or more fluids filling each hollow core of the one or more hollow-core fiber; and
wherein a wavelength of the pump laser, the one or more hollow-core fiber, and the one or more fluids are selected and configured so that stimulated Raman scattering Stokes and anti-Stokes orders are substantially generated in one or more atmospheric transmission windows.

2. The nonlinear fiber-optic source of claim 1, wherein the stimulated Raman scattering Stokes and anti-Stokes orders are completely generated in the one or more atmospheric transmission windows.

3. The nonlinear fiber-optic source of claim 1, wherein the stimulated Raman scattering Stokes and anti-Stokes orders are generated in at least three of the one or more atmospheric transmission windows.

4. The nonlinear fiber-optic source of claim 1, wherein the one or more fluids filling the hollow core of the one or more hollow-core fiber is one or more gas.

5. The nonlinear fiber-optic source of claim 1, wherein the one or more gas filling the hollow core of the one or more hollow-core fiber comprises O₂ gas.

6. The nonlinear fiber-optic source of claim 1, wherein the one or more hollow-core fiber is an anti-resonant hollow-core photonic crystal fiber and the one or more fluid is one or more gas or one or more low index liquid.

7. The nonlinear fiber-optic source of claim 1, wherein the one or more hollow-core fiber is a hollow-core photonic crystal fiber or hollow capillary and the fluid is one or more high index liquid.

8. The nonlinear fiber-optic source of claim 1, wherein the one or more fluid is a mixture of at least two gases.

9. The nonlinear fiber-optic source of claim 1, wherein the one or more hollow-core fiber is an anti-resonant hollow-core fiber and the one or more fluid comprises O₂ gas, the wavelength of the pump laser is about 1.01 to 1.08 um, and wherein stimulated Raman scattering Stokes and anti-Stokes orders are generated in at least three of the one or more atmospheric transmission windows.

10. A LiDAR system, comprising:
a laser for delivering broadband multispectral beam pulses that are directed toward and reflected off a target located within the atmosphere;
at least one detector receiving the beam pulses after the beam pulses are deflected off the target; and
wherein the laser includes a pump laser and a nonlinear fiber-optic source;
wherein the nonlinear fiber-optic source includes one or more hollow-core fiber, with each hollow core fiber having a hollow core, one or more fluid filling the hollow core of the one or more hollow-core fiber, and wherein a wavelength of the pump laser, the one or more hollow-core fiber, and the one or more fluids are selected and configured so that stimulated Raman scattering Stokes and anti-Stokes orders are substantially generated in one or more atmospheric transmission windows and in one or more response windows of the at least one detector.

11. The LiDAR system of claim 10, wherein the stimulated Raman scattering Stokes and anti-Stokes orders are completely generated in the one or more atmospheric transmission windows.

12. The LiDAR system of claim 10, wherein the stimulated Raman scattering Stokes and anti-Stokes orders are generated in at least three of the one or more atmospheric transmission windows.

13. The LiDAR system of claim 10, wherein the one or more fluid filling the hollow core of the one or more hollow-core fiber is at least one gas.

14. The LiDAR system of claim 10, wherein the one or more gas filling the hollow core of the at least one hollow-core fiber comprises O₂ gas.

15. The LiDAR system of claim 10, wherein the one or more hollow-core fiber is an anti-resonant hollow-core photonic crystal fiber and the one or more fluid is a gas or a low index liquid.

16. The LiDAR system of claim 10, wherein the one or more hollow-core fiber is a hollow-core photonic crystal fiber or hollow capillary and the one or more fluid is a high index liquid.

17. The LiDAR system of claim 10, wherein the one or more fluid is a mixture of at least two gases.

18. The LiDAR system of claim 10, wherein the one or more hollow-core fiber is an anti-resonant hollow-core fiber and the one or more fluid comprises O₂ gas, the wavelength of the pump laser is about 1.01 to 1.08 um, and wherein stimulated Raman scattering Stokes and anti-Stokes orders are generated in at least three of the one or more atmospheric transmission windows.

19. £ The LiDAR system of claim 10, further comprising dispersive optics that temporally disperses the wavelengths of the reflected beam pulse to produce a temporally dispersed beam pulse which is directed to the at least one detector which is only one single-pixel sensor detector.

20. A method of producing an efficient atmospheric transmission from broadband multispectral laser, comprising the steps of:
selecting one or more spectral ranges within which emission will be generated;
obtaining a pump laser that produces a wavelength on a short wavelength side of the selected one or more spectral ranges;
determining which Raman shifts are necessary to go from the pump laser wavelength to one or more selected spectral ranges;
obtaining a nonlinear fiber-optic source for use with the pump laser to produce broadband multispectral beam pulses;
wherein the nonlinear fiber-optic source comprises one or more hollow-core fiber; and
selecting at least one liquid or at least one gas for filling the one or more hollow-core fiber to provide the determined Raman shifts and having sufficient optical transmission and nonlinear gain to support efficient Raman generation.
